(19) United States
(12) Patent Application Publication
(10) Pub. No.: US 2026/0018612 A1
(43) Pub. Date: Jan. 15, 2026

(54) NEGATIVE ELECTRODE ACTIVE MATERIAL FOR RECHARGEABLE LITHIUM BATTERY, METHOD FOR PREPARING THE SAME, NEGATIVE ELECTRODE INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Hang In CHO, Suwon-si (KR); Jae Hou NAH, Suwon-si (KR); Joong Ho MOON, Suwon-si (KR); Se Young OH, Suwon-si (KR); Yu Rim CHA, Suwon-si (KR); So Jeong YU, Suwon-si (KR); Dong Min MOON, Suwon-si (KR)

(21) Appl. No.: 19/267,274

(22) Filed: Jul. 11, 2025

(30) Foreign Application Priority Data
Jul. 12, 2024 (KR) 10-2024-0092627

(51) Int. Cl. H01M 4/587; D01D 1/02; D01D 5/00; D01F 6/52; D01F 6/54; D01F 9/22; H01M 10/052

(52) U.S. Cl. CPC H01M 4/587; D01D 1/02; D01D 5/0038; D01F 6/52; D01F 6/54; D01F 9/22; H01M 10/052; D10B 2321/08; D10B 2321/10; D10B 2505/00

(57) ABSTRACT

The present disclosure relates to a negative electrode active material for a rechargeable lithium battery, a method for preparing the same, a rechargeable lithium battery including the same, and the negative electrode active material for a rechargeable lithium battery includes a carbon nanofiber bundle including a plurality of carbon nanofibers, wherein the carbon nanofiber bundle exhibits H1, H3, and H4 hysteresis in a gas adsorption-desorption isotherm curve, and, in the gas adsorption-desorption isotherm curve, an adsorption curve and a desorption curve do not meet in all of a first region in which a relative pressure (P/P₀) is 0.8 or higher, a second region in which the relative pressure (P/P₀) is less than 0.8 and 0.4 or more, and a third region in which the relative pressure (P/P₀) is less than 0.4.

### CROSS-REFERENCE TO RELATED APPLICATION

The present application claims priority to and the benefit of Korean Patent Application No. 10-2024-0092627, filed on Jul. 12, 2024, in the Korean Intellectual Property Office, the entire disclosure of which is incorporated herein by reference.

### BACKGROUND

### 1. Field

One or more embodiments of the present disclosure relate to a negative electrode active material for a rechargeable lithium battery, a method for preparing the same, a negative electrode for a rechargeable lithium battery including the same, and a rechargeable lithium battery including the same.

### 2. Description of Related Art

Recently, with the rapid spread and popularization of electronic devices that use batteries, such as mobile phones, notebook computers, and electric vehicles, the demand for rechargeable batteries with relatively high energy density and high capacity has rapidly increased. Accordingly, research and development to improve the performance of such rechargeable batteries, such as rechargeable lithium batteries, has been actively conducted.

The rechargeable lithium batteries are batteries including a positive electrode and a negative electrode, each of which includes an active material capable of intercalation and deintercalation of lithium ions, and an electrolyte, and generate electric energy through an oxidation-reduction reaction occurring when lithium ions are intercalated/deintercalated into/from the positive electrode and the negative electrode. For example, the electrical energy is generated when lithium ions are intercalated into the positive electrode and/or deintercalated from the negative electrode during the discharge process.

### SUMMARY

One or more aspects of embodiments of the present disclosure are directed toward a negative electrode active material for a rechargeable lithium battery that exhibits a fast charge/discharge rate and high efficiency.

One or more aspects of embodiments of the present disclosure are directed toward a method for preparing a negative electrode active material for a rechargeable lithium battery, a negative electrode including the same, and a rechargeable lithium battery including the same.

Additional aspects will be set forth in part in the description which follows and, in part, will be apparent from the description, or may be learned by practice of the presented embodiments of the disclosure.

According to one or more embodiments of the present disclosure, a negative electrode active material for a rechargeable lithium battery includes a carbon nanofiber bundle including a plurality of carbon nanofibers, wherein the carbon nanofiber bundle exhibits H1, H3, and H4 hysteresis in a gas adsorption-desorption isotherm curve, and, in the gas adsorption-desorption isotherm curve, an adsorption curve and a desorption curve do not meet in all of a first region in which a relative pressure (P/P₀) is 0.8 or higher, a second region in which the relative pressure (P/P₀) is less than 0.8 and 0.4 or more, and a third region in which the relative pressure P/P₀) is less than 0.4.

According to one or more embodiments of the present disclosure, there is provided a method for preparing a negative electrode active material for a rechargeable lithium battery, the method including preparing a first solution including a solvent, a first carbon-containing polymer whose Flory-Huggins parameter with respect to the solvent is F1, and a second carbon-containing polymer whose Flory-Huggins parameter with respect to the solvent is F2, wherein an absolute value of a difference between F1 and F2 is about 0.4 or more, performing phase separation on the first solution to obtain a second solution including an intermediate layer, and electrospinning and thermally treating the second solution to prepare a carbon nanofiber bundle including a plurality of carbon nanofibers.

According to one or more embodiments of the present disclosure, a negative electrode for a rechargeable lithium battery includes the negative electrode active material for a rechargeable lithium battery.

According to one or more embodiments of the present disclosure, a rechargeable lithium battery includes the negative electrode including the negative electrode active material for a rechargeable lithium battery, and a positive electrode.

### DETAILED DESCRIPTION OF THE DRAWINGS

The accompanying drawings are included to illustrate example embodiments of the present disclosure and serve to facilitate understanding of the technical idea of the present disclosure together with the detailed description of the description provided herein, the present disclosure should not be limitedly interpreted on the basis of the drawings. The above and other objects, features, and advantages of the present disclosure will become more apparent and appreciated to those of ordinary skill in the art from the following descriptions of example embodiments thereof in detail with reference to the accompanying drawings, in which:

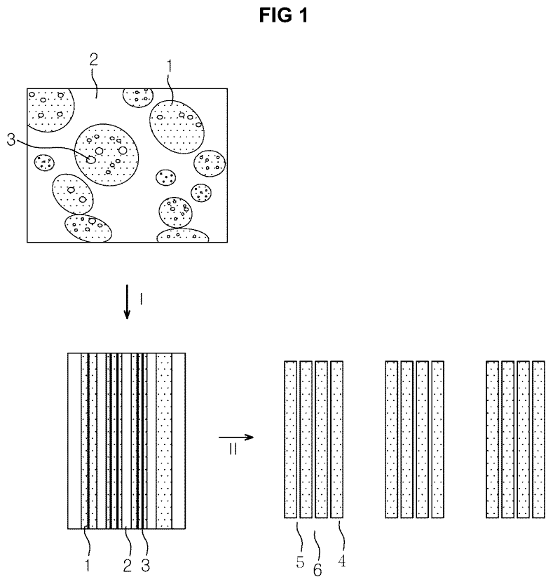

FIG. 1 is a conceptual diagram illustrating a method for implementing multi lithium-ion transfer channels in a carbon nanofiber bundle prepared using a preparation method according to one or more embodiments of the present disclosure;

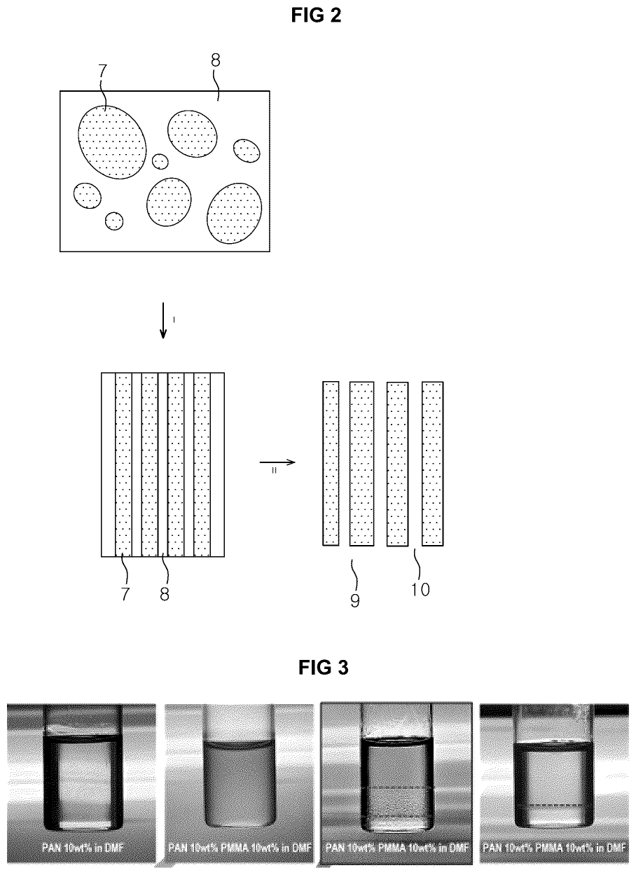

FIG. 2 is a conceptual diagram illustrating a conventional method for implementing carbon nanofibers including channels;

FIG. 3 illustrates an example of a phase separation process in the preparation method of the carbon nanofiber bundle according to one or more embodiments of the present disclosure;

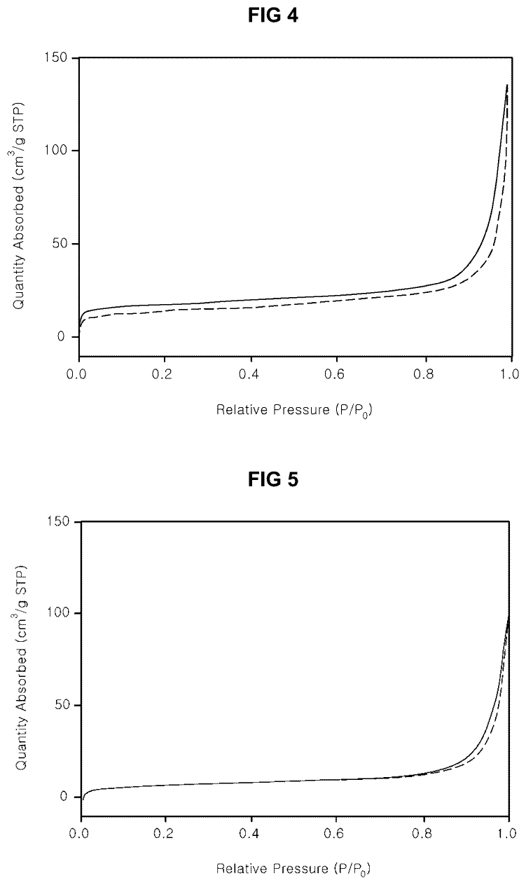

FIG. 4 shows a gas adsorption-desorption isotherm curve of the carbon nanofiber bundle according to one or more embodiments of the present disclosure;

FIG. 5 shows a gas adsorption-desorption isotherm curve of a carbon nanofiber bundle prepared according to the method described in FIG. 2;

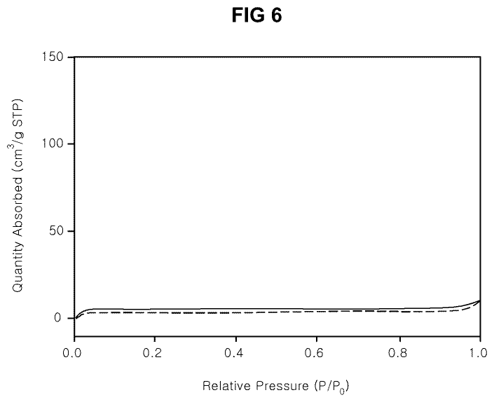

FIG. 6 shows a gas adsorption-desorption isotherm curve of carbon nanofibers in which no pore channels are formed;

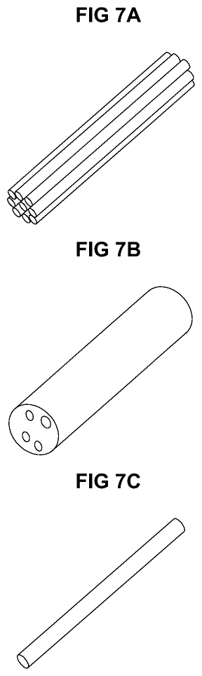

FIG. 7A is a conceptual diagram of the carbon nanofiber bundle according to one or more embodiments of the present disclosure;

FIG. 7B is a conceptual diagram of carbon nanofibers corresponding to FIG. 5 and prepared using the method described in FIG. 2;

FIG. 7C is a conceptual diagram of carbon nanofibers corresponding to FIG. 6;

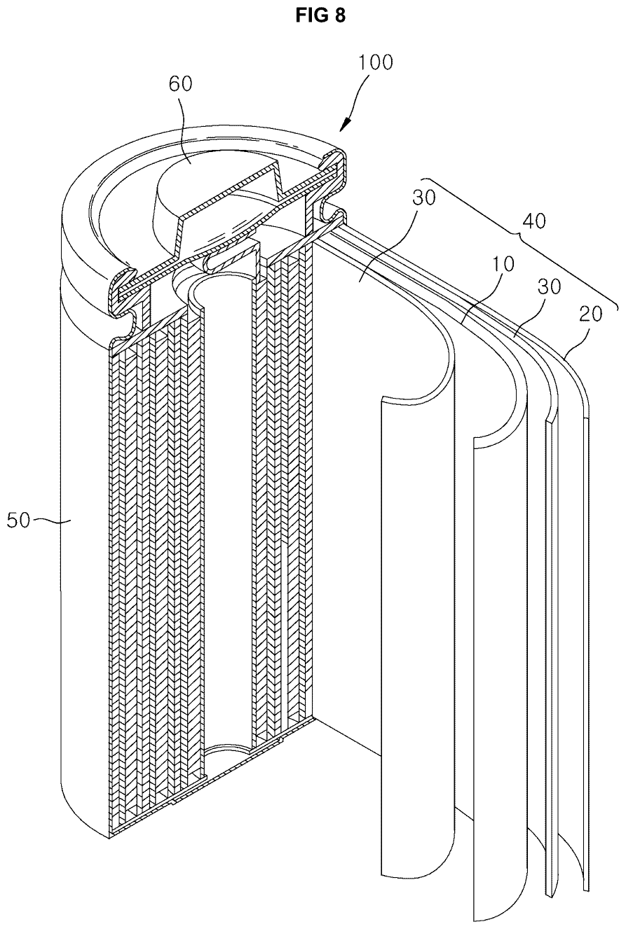

FIGS. 8-11 are each a schematic view of a rechargeable lithium battery according to one or more embodiments of the present disclosure;

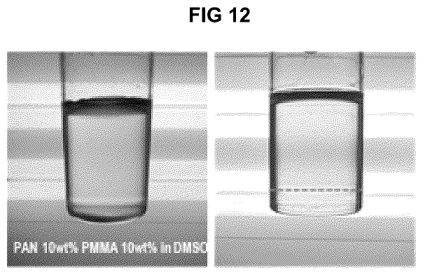

FIG. 12 illustrates an example of a phase separation process of a solution, observed over standing time, according to Comparative Example 1 of the present disclosure;

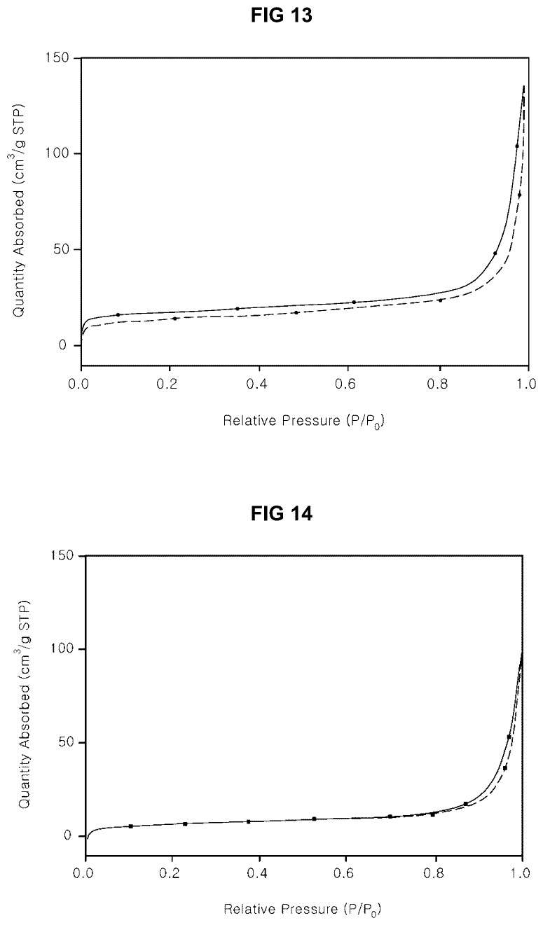

FIGS. 13 to 15 illustrate results presented as nitrogen adsorption-desorption isotherm curves for Example 1, Comparative Example 1, and Comparative Example 2 of the present disclosure, respectively;

FIG. 16 illustrates pore volumes as a function of pore width for nanofibers of the example and comparative examples of the present disclosure, wherein ● represents the results of Example 1, ▪ represents the results of Comparative Example 1, and ▴ represents the results of Comparative Example 2;

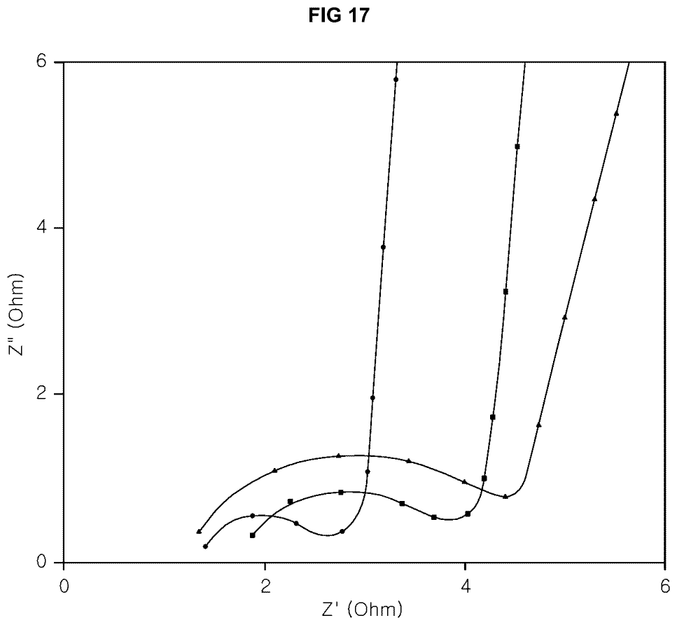

FIG. 17 illustrates electrochemical impedance spectroscopy (EIS) measurement results for the nanofibers of the example and comparative examples of the present disclosure, wherein ● represents the results of Example 1, ▪ represents the results of Comparative Example 1, and ▴ represents the results of Comparative Example 2;

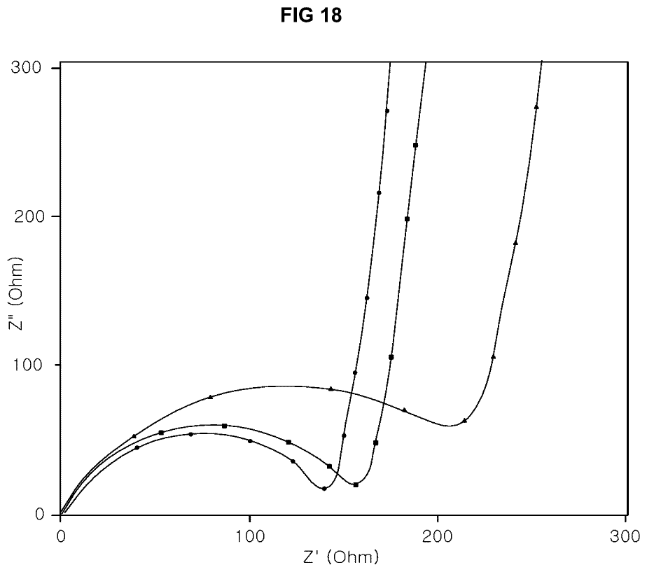

FIG. 18 illustrates lithium-ion diffusion coefficient results for electrodes including the nanofibers of the example and comparative examples of the present disclosure, measured before 500 cycles, wherein ● represents the results of Example 1, ▪ represents the results of Comparative Example 1, and ▴ represents the results of Comparative Example 2;

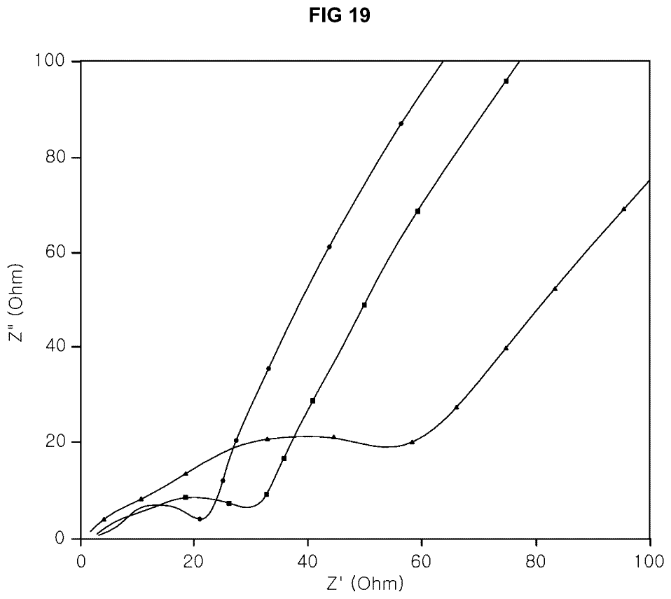

FIG. 19 illustrates lithium-ion diffusion coefficient results for the electrodes including the nanofibers of the example and comparative examples of the present disclosure, measured after 500 cycles, wherein ● represents the results of Example 1, ▪ represents the results of Comparative Example 1, and ▴ represents the results of Comparative Example 2.

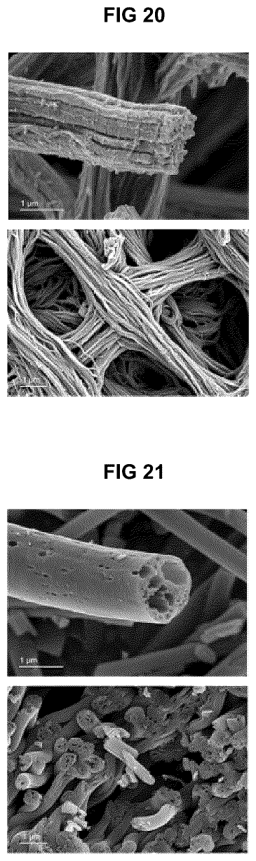

FIG. 20 illustrates scanning electron microscope (SEM) photographs for a carbon nanofiber bundle of Example 1 of the present disclosure;

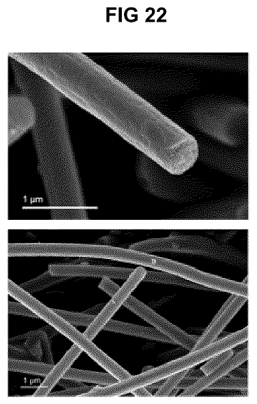

FIG. 21 illustrates SEM photographs for carbon nanofibers of Comparative Example 1 of the present disclosure; and

FIG. 22 illustrates SEM photographs for carbon nanofibers of Comparative Example 2 of the present disclosure.

### DETAILED DESCRIPTION

Hereinafter, one or more embodiments of the present disclosure will be described in detail with reference to the accompanying drawings. However, these embodiments are presented as examples, and the present disclosure is not limited thereby, and the present disclosure is only defined by the scope of the appended claims and equivalents thereof.

Unless otherwise specified herein, when a part such as a layer, a film, an area, or a plate is described as being “on” another part, this may include not only embodiments in which the part is “directly on” the other part, but also embodiments in which one or more intervening parts are present therebetween. In contrast, when a part such as a layer, a film, an area, or a plate is described as being “directly on” another part, there is no intervening part present therebetween.

Unless otherwise specified herein, a singular expression may also include a plural meaning, for example, the singular forms “a,” “an,” “one,” and “the” are intended to include the plural forms as well, unless the context clearly indicates otherwise. In addition, unless otherwise specified, “A and/or B” or “A or B” or “A/B” may refer to “including A, including B, or including A and B.” Expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. Further, the utilization of “may” when describing embodiments of the present disclosure refers to “one or more embodiments of the present disclosure.”

As used herein, “a combination thereof” may mean a mixture, a laminate, a composite, a copolymer, an alloy, a blend, a reaction product, and/or the like of constituting components.

Unless otherwise defined herein, the term “particle diameter” or “particle size” may refer to an average particle diameter/size. In addition, the particle diameter or “particle size” refers to an average particle diameter/size (D₅₀), which means a diameter/size of particles with a cumulative volume of 50% by volume in a particle size distribution. The average particle diameter (D₅₀) may be measured by a method well known to those skilled in the art, for example, by a particle size analyzer, or by a transmission electron microscope or a scanning electron microscope. In one or more embodiments, a dynamic light-scattering measurement device may be used, for example, after measuring using a measuring device using dynamic light-scattering, performing data analysis, counting the number of particles for each particle size range, and then calculating, the value of the average particle diameter (D₅₀) may be easily obtained. In one or more embodiments, the average particle diameter (D₅₀) may be measured by a laser diffraction method. For example, when measured by the laser diffraction method, the average particle diameter (D₅₀) may be measured by dispersing particles to be measured in a dispersion solvent and introducing the dispersed particles to a commercially available laser diffraction particle size measuring device (e.g., MT 3000 available from Microtrac, Ltd.), irradiating ultrasonic waves of about 28 kHz at a power of 60 W, and calculating an average particle diameter (D₅₀) in the 50 volume % standard of particle size distribution in the measuring device. In the present disclosure, D₅₀ refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. In the present disclosure, when particles are spherical, “diameter” indicates a particle diameter or an average particle diameter, and when the particles are non-spherical, the “diameter” indicates a major axis length or an average major axis length.

A negative electrode active material for a rechargeable lithium battery according to one or more embodiments includes a carbon nanofiber bundle including a plurality of carbon nanofibers. The plurality of carbon nanofibers is provided with (e.g., includes) pore channels formed as void spaces therebetween. A plurality of pore channels is included within the carbon nanofiber bundle. The pore channels enable the movement of lithium ions and electrons, which allows the negative electrode active material to exhibit a fast charge/discharge rate and high efficiency.

First, a method for preparing the carbon nanofiber bundle according to one or more embodiments will be described.

The method for preparing the carbon nanofiber bundle may include preparing a first solution including a solvent, a first carbon-containing polymer whose Flory-Huggins parameter with respect to the solvent is F1, and a second carbon-containing polymer whose Flory-Huggins parameter with respect to the solvent is F2, wherein an absolute value of a difference between F1 and F2 is about 0.4 or more, phase separating the first solution to obtain a second solution including an intermediate layer, and electrospinning and thermally treating the second solution to prepare a carbon nanofiber bundle including carbon nanofibers.

FIG. 1 is a conceptual diagram illustrating a method for implementing multi lithium-ion transfer channels in carbon nanofibers prepared using a preparation method according to one or more embodiments of the present disclosure.

Referring to FIG. 1, the intermediate layer includes a sea-island structure including island regions 1 containing the first carbon-containing polymer and a sea region 2 made of the second carbon-containing polymer.

The island region 1 further includes island regions 3, which contain a small amount of the second carbon-containing polymer and are formed in the island region 1 by secondary phase separation to be described below. The island regions 3 containing the second carbon-containing polymer within the island region 1 are spaced and/or apart (e.g., spaced apart or separated) from each other.

When the second solution including the intermediate layer is electrospun (I) and thermally treated (II) at a set or predetermined temperature, both the second carbon-containing polymer in the sea region 2 and the second carbon-containing polymer in the island region 3 are removed, thereby forming a carbon nanofiber bundle 6 in which pore channels 5 are formed between carbon nanofibers 4. The pore channels act as lithium-ion transport channels and electron transport paths, thereby allowing the carbon nanofiber bundle to exhibit a fast charge/discharge rate and high efficiency.

The pore channels may contribute to preventing an adsorption curve and a desorption curve in a second region of the carbon nanofiber bundle to be described below from meeting (e.g., coinciding).

In contrast, FIG. 2 is a conceptual diagram illustrating the preparation of carbon nanofibers without the secondary phase separation.

Referring to FIG. 2, an electrospinning solution with a sea-island structure consisting of an island region 7 containing the first carbon-containing polymer and a sea region 8 made of the second carbon-containing polymer is prepared. The electrospinning solution does not have the intermediate layer described in FIG. 1 because the secondary phase separation was not performed.

When the electrospinning solution is electrospun (I) and thermally treated (II) at a set or predetermined temperature, only the second carbon-containing polymer in the sea region is removed, thereby forming pore channels 10 between carbon nanofibers 9. FIG. 2 is a conceptual diagram of a method for preparing carbon nanofibers according to Comparative Example 1 to be described below.

When comparing FIG. 1 and FIG. 2, the carbon nanofiber bundle in FIG. 1 has pore channels formed at a higher frequency between the carbon nanofibers compared to the carbon nanofibers in FIG. 2, thereby enhancing the extent of lithium ion movement and electron transfer, which results in a fast charge/discharge rate and high efficiency.

### (1) Preparation of First Solution

The first solution is prepared by mixing a solvent, a first carbon-containing polymer with a Flory-Huggins parameter F1 with the solvent, and a second carbon-containing polymer with a Flory-Huggins parameter F2 with the solvent, wherein the absolute value of a difference between F1 and F2 is about 0.4 or more.

In the above-described preparation method, the Flory-Huggins parameters between the first carbon-containing polymer and the solvent, and between the second carbon-containing polymer and the solvent are considered to facilitate the secondary phase separation to be described below. When the absolute value of the difference between the F1 and the F2 is about 0.4 or more, mixing the solvent, the first carbon-containing polymer, and the second carbon-containing polymer results in the formation of a sea-island structure with island regions containing the first carbon-containing polymer and a sea region made of the second carbon-containing polymer. As a small amount of the second carbon-containing polymer in the island region is placed, even within the island region, it becomes easier to form island regions, which contain the second carbon-containing polymer and are spaced and/or apart from each other.

Although not particularly limited, in one or more embodiments, the Flory-Huggins parameter may be calculated by Equation 1 below, which is commonly known to those skilled in the art,

$${χ}_{ii} = {VA}_{i , i} / RT {A}_{i , j} = [ {( {δ}_{dj} - {δ}_{di} )}^{2} + 0.25 {( {δ}_{pj} - {δ}_{pi} )}^{2} + 0.25 {( {δ}_{hj} - {δ}_{hi} )}^{2} ] \qquad Equation 1$$

where xᵢⱼ denotes a Flory-Huggins parameter of polymer (i)-solvent (j), V is molar volume, R is the gas constant, T is temperature, δ_{di}, δₚᵢ, and δₕᵢ denote Hansen solubility parameters contributed from dispersion force (d), polar force (p), and hydrogen-bonding (h) effects, respectively, for polymer, δ_{dj}, δₚⱼ, and δₕⱼ denote Hansen solubility parameters contributed from dispersion force (d), polar force (p), and hydrogen-bonding (h) effects, respectively, for solvent.

In one or more embodiments, the absolute value of the difference between F1 and F2 is about 0.4 or more, for example, between about 0.4 and about 0.8, between about 0.4 and about 0.7, or between about 0.4 and about 0.5.

In one or more embodiments, F1 is greater than F2, and may be, for example, about 0.6 or more, between about 0.6 and about 0.8, or between about 0.6 and about 0.7.

In one or more embodiments, F2 may be, for example, about 0.1 or more, between about 0.1 and about 0.4, or between about 0.1 and about 0.3.

The first carbon-containing polymer and the second carbon-containing polymer, each of which is suitable for electrospinning, may be selected for use if (e.g., when) they satisfy the condition that the absolute value of the difference between F1 and F2 is about 0.4 or more. For example, in one or more embodiments, the first carbon-containing polymer and the second carbon-containing polymer may be independently selected from one or more of polyacrylonitrile and polymethyl methacrylate, but embodiments of the present disclosure are not limited thereto.

In one or more embodiments, a weight-average molecular weight of the first carbon-containing polymer may range from about 85,000 to about 200,000 g/mol, for example, from about 100,000 to about 1,700,000 g/mol, for example, about 150,000 g/mol. In the above range, the preparation of the intermediate layer may be facilitated.

In one or more embodiments, a weight-average molecular weight of the second carbon-containing polymer may range from about 90,000 to about 350,000 g/mol, for example, from about 90,000 to about 150,000 g/mol, for example, may be about 120,000 g/mol. In the above range, the preparation of the intermediate layer may be facilitated.

The “weight-average molecular weight” of a polymer may be determined as a polystyrene equivalent value using gel permeation chromatography.

The first carbon-containing polymer and the second carbon-containing polymer may be included in the first solution at a set or predetermined weight ratio. In one or more embodiments, the first carbon-containing polymer and the second carbon-containing polymer may be included in a weight ratio ranging from about 1:0.5 to about 1:3, for example, from about 1:0.8 to about 1:2, or from about 1:1 to about 1:1.5.

For example, in one or more embodiments, the first carbon-containing polymer may be included in the first solution in an amount ranging from about 1 wt % to about 30 wt %, for example, from about 1 wt % to about 20 wt %, or from about 1 wt % to about 10 wt %, based on a total weight of 100 wt % of the first solution. For example, in one or more embodiments, the second carbon-containing polymer may be included in the solution in an amount ranging from about 1 wt % to about 30 wt %, for example, from about 1 wt % to about 20 wt %, or from about 1 wt % to about 10 wt %, based on the total weight of 100 wt % of the first solution.

The solvent is not limited in type as long as the absolute value of the difference between F1 and F2 is about 0.4 or more. For example, in one or more embodiments, the solvent may include one or more selected from among dimethylformamide (DMF), dimethylacetamide, methylpyrrolidone, and dimethyl sulfoxide.

In one or more embodiments, the first solution may include polyacrylonitrile as the first carbon-containing polymer, polymethyl methacrylate as the second carbon-containing polymer, and dimethylformamide as the solvent.

### (2) Preparation of Second Solution Including Intermediate Layer

The first solution prepared in (1) (i.e., the step of Preparation of first solution) is phase-separated to obtain a second solution including an intermediate layer. For example, the second solution may be obtained at a stage before the first solution prepared in (1) is completely separated into two phases through spontaneous phase separation. Here, “spontaneous phase separation” refers to the process in which the phases naturally separate within the solution by standing without stirring. For example, the second solution may be composed of the intermediate layer or may be essentially consisting of the intermediate layer.

The first solution prepared in (1) is a uniform single phase immediately after preparation. However, when the solution undergoes spontaneous phase separation, the solution separates into two phases, and the intermediate layer may be obtained at a stage between the single phase and the two phases. The intermediate layer may include the sea-island region described in FIG. 1.

The preparation of the intermediate layer is achieved by adjusting a standing time to induce phase separation in the first solution prepared in step (1). In one or more embodiments, the standing time may range from about 48 to about 72 hours, but the standing time may be adjusted depending on the type and/or respective contents (amounts) of the solvent, the first carbon-containing polymer, and the second carbon-containing polymer. Whether the intermediate layer has been formed by the phase separation described above can be visually identified, for example, by the naked eye or the like.

FIG. 3 illustrates an example of the phase separation process in the preparation method according to one or more embodiments of the present disclosure. Referring to FIG. 3, it may be confirmed that as the standing time elapses in the uniform single phase, the solution separates into two phases, and the intermediate layer is formed at the stage between the single phase and the two phases.

In one or more embodiments, a total concentration of the first carbon-containing polymer and the second carbon-containing polymer in the second solution including the intermediate layer may range from about 5 wt % to about 20 wt %. In the above range, the preparation of a carbon nanofiber bundle including carbon nanofibers may be facilitated.

### (3) Preparation of Carbon Nanofiber Bundle Including Carbon Nanofibers

The second solution including the intermediate layer prepared in (2) (i.e., the step of Preparation of second solution including intermediate layer) is electrospun and thermally treated to prepare a carbon nanofiber bundle including carbon nanofibers.

Nanofibers with the sea-island region described in FIG. 1 may be prepared by an electrospinning.

The electrospinning may be performed using a conventional method known to those skilled in the art. For example, the electrospinning may be performed under the following conditions.

The electrospinning is preferably performed in an environment with a temperature of 25° C. or lower, for example, greater than 18° C. to 23° C. In the above range, the degree of solvent evaporation in the electrospinning solution is reduced, and thus some residual solvent remains after the electrospinning, thereby facilitating the formation of the island region.

The electrospinning may be performed by positioning one nozzle pack consisting of a tip with a needle size ranging from 23 gauge (G) to 30 gauge (G) and a collector roller to be spaced apart by a certain distance, adding the second solution including the intermediate layer to the tip, positioning the tip over the collector roller, and then, applying a voltage of about 10 kV to about 50 kV to the tip. The distance between the nozzle pack and the collector roller may range from about 10 centimeters (cm) to about 20 cm. In the case in which the needle size of the tip ranges from 25G to 30G, carbon nanofibers of the desired form may be formed, which may be appropriate.

As the second solution is electrospun and stretched into fiber form according to the electrospinning process, a layer including nanofibers may be formed. This occurs as the second solution hangs at the end of the tip in the form of a droplet due to surface tension, and when a voltage is applied, charges accumulate on the surface of the solution, and a repulsive force is created from the charges. When the repulsive force between the charges reaches a critical voltage higher than the surface tension of the solution, a cone-shaped Taylor cone is formed, and at the tip of the cone, a jet of the electrospinning solution is ejected, and undergoes high elongation to form nanofibers, which are collected on the collector roller, thereby completing the formation of nanofibers.

An air pressure at the nozzle may be about 1 MPa or less, for example, between about 0.05 MPa and about 0.8 MPa.

To minimize interference between the tips and ensure uniform electrospinning, it is desirable to properly adjust tip air. In one or more embodiments, the tip air may be adjusted by blowing compressed air at a pressure of about 0.1 MPa to about 0.3 MP.

A roller speed of the collector roller may be adjusted to ensure that nanofibers are formed with an appropriate diameter, for example, at a speed ranging from about 0.1 m/min to about 3 m/min. In addition, a flow rate of the electrospinning solution ejected from the tip may be adjusted to range from about 20 μL/min to about 200 μL/min.

In one or more embodiments, after performing the electrospinning process, a drying process may be performed at a temperature ranging from about 20° C. to about 30° C.

The thermal treatment involves removing only the second carbon-containing polymer from the nanofibers prepared by the electrospinning, thereby preparing the carbon nanofibers.

The thermal treatment temperature may be adjusted depending on the type of the second carbon-containing polymer, the content (e.g., amount) of the second carbon-containing polymer in the intermediate layer, and the like. In one or more embodiments, the thermal treatment temperature may range from about 500° C. to about 1000° C., for example, from about 600° C. to about 900° C.

The thermal treatment time may be adjusted depending on the type of the second carbon-containing polymer, the content (e.g., amount) of the second carbon-containing polymer in the intermediate layer, and the like. In one or more embodiments, the thermal treatment time may range from about 1 hour to 10 hours, for example, from about 1 hour to about 5 hours.

The thermal treatment may be performed under a nitrogen atmosphere.

Next, the negative electrode active material for a rechargeable lithium battery according to one or more embodiments will be described.

The negative electrode active material for a rechargeable lithium battery according to one or more embodiments includes a carbon nanofiber bundle including a plurality of carbon nanofibers, and the carbon nanofiber bundle exhibits H1, H3, and H4 hysteresis in a gas adsorption-desorption isotherm curve. In the gas adsorption-desorption isotherm curve, the adsorption curve and the desorption curve do not meet or coincide in all three regions, which are a first region in which a relative pressure (P/P₀) is 0.8 or higher, a second region in which the relative pressure (P/P₀) is less than 0.8 and 0.4 or more, and a third region in which the relative pressure (P/P₀) is less than 0.4.

In one or more embodiments, the negative electrode active material for a rechargeable lithium battery includes a carbon nanofiber bundle that exhibits H1 hysteresis in the first region of the gas adsorption-desorption isotherm curve, in which the relative pressure (P/P₀) is 0.8 or higher. The carbon nanofiber bundle also exhibits H3 and H4 type hysteresis in the second and third regions, in which the relative pressure (P/P₀) is less than 0.8 and 0.4 or more, and less than 0.4, respectively. In all three regions, the adsorption and desorption curves do not meet.

FIG. 4 shows the gas adsorption-desorption isotherm curve of the carbon nanofibers according to one or more embodiments of the present disclosure.

Referring to FIG. 4, in the carbon nanofiber bundle, the adsorption curve and the desorption curve do not meet in the first region in which the relative pressure (P/P₀) is 0.8 or higher. This means that cylindrical pores with a size (pore size) ranging from about 50 nm to about 200 nm in diameter are formed between the carbon nanofibers in the carbon nanofiber bundle.

Referring to FIG. 4, the carbon nanofiber bundle also shows no intersection between the adsorption and desorption curves in the second region, in which the relative pressure (P/P₀) is less than 0.8 and 0.4 or more, and in the third region, in which the relative pressure (P/P₀) is less than 0.4, thereby forming an open hysteresis curve. This means that pores with a smaller diameter than the cylindrical pore are formed between the carbon nanofibers in the carbon nanofiber bundle. For example, these pores may have a tapered shape, wedge shape, or slit shape when taking into account H3 or H4 type hysteresis. Through this, the carbon nanofibers can increase the movement of lithium ions to achieve fast charge and discharge.

In contrast, FIG. 5 shows a gas adsorption-desorption isotherm curve of carbon nanofibers prepared according to the method described in FIG. 2.

Referring to FIG. 5, the carbon nanofibers exhibit H1 hysteresis, in which the adsorption and desorption curves do not meet in the first region, but in the second region, the adsorption and desorption curves meet and coincide.

In contrast, FIG. 6 shows a gas adsorption-desorption isotherm curve of carbon nanofibers in which no pore channels are formed. Referring to FIG. 6, the carbon nanofibers exhibit no H1 hysteresis in the gas adsorption-desorption isotherm curve.

As a result, the carbon nanofibers shown in FIG. 5 and FIG. 6 are less capable of facilitating fast charge and discharge through enhanced lithium ion movement, compared to the carbon nanofiber bundle shown in FIG. 4.

Next, a method for obtaining the gas adsorption-desorption isotherm curve of the carbon nanofibers will be described. The gas adsorption-desorption isotherm curve may be measured by nitrogen adsorption at 77K under a pressure of 1 bar using a static volumetric gas adsorption instrument (e.g., Micrometrics ASAP 2020). The gas adsorption-desorption isotherm curve may be obtained after a sample is pre-outgassed at about 150° C. for about 10 hours.

The carbon nanofiber bundle includes a plurality of carbon nanofibers with a high aspect ratio, and pore channels composed of void spaces may be present between the carbon nanofibers.

FIGS. 7A to 7B are each a conceptual diagram of carbon nanofibers. FIG. 7A is a conceptual diagram of the carbon nanofiber bundle according to one or more embodiments of the present disclosure, FIG. 7B is a conceptual diagram of carbon nanofibers corresponding to FIG. 5 and prepared using the method described in FIG. 2, and FIG. 7C is a conceptual diagram of carbon nanofibers corresponding to FIG. 6.

Referring to FIG. 7A, the carbon nanofiber bundle includes a sea-island structure including (e.g., consisting of) islands, which are regions including the first carbon-containing polymer, and a sea, which is a region including the second carbon-containing polymer, and in the island, the first carbon-containing polymer includes (e.g., results) carbon nanofibers prepared by electrospinning and thermal treatment of a solution in which the first carbon-containing polymer is spaced apart in an island form. The carbon nanofiber bundle has pore channels composed of void spaces between the carbon nanofibers.

Referring to FIG. 7B, carbon nanofibers prepared by electrospinning and thermal treatment of a solution with a sea-island structure, which consists of island regions containing the first carbon-containing polymer and a sea region made of the second carbon-containing polymer, are illustrated. This means that a plurality of pore channels, which are composed of void spaces, exist only within the nanofibers.

Referring to FIG. 7C, carbon nanofibers, which are produced by electrospinning and thermal treatment of a carbon-containing polymer, such as the first carbon-containing polymer alone, are illustrated. The carbon nanofibers do not have any pore channels composed of void spaces.

In one or more embodiments, the pore channels between the carbon nanofibers in the carbon nanofiber bundle may have an average diameter ranging from about 50 nm to about 150 nm, for example, from about 75 nm to about 100 nm.

In one or more embodiments, the carbon nanofiber bundle may have a specific surface area ranging from about 30 m² g⁻¹ to about 100 m² g⁻¹, for example, from about 40 m² g⁻¹ to about 60 m² g⁻¹. The specific surface area may be a Brunauer-Emmett-Teller (BET) specific surface area.

In one or more embodiments, the carbon nanofiber bundle may have a pore volume of about 0.2 cm³ g⁻¹ or more, for example, ranging from about 0.2 cm³ g⁻¹ to about 1 cm³ g⁻¹.

The specific surface area and the pore volume can be determined using a static volumetric gas adsorption instrument (e.g., Micrometrics ASAP 2020) and the BET equation.

In one or more embodiments of the present disclosure, a negative electrode for a rechargeable lithium battery may include the negative electrode active material for a rechargeable lithium battery according to one or more embodiments, the negative electrode active material including the carbon nanofiber bundle according to one or more embodiments.

In one or more embodiments, the carbon nanofiber bundle may be included between about 90 wt % and 100 wt % of the negative electrode active material, for example, between about 95 wt % and 100 wt % or 100 wt %.

The negative electrode may further include a binder and/or a conductive material in addition to the negative electrode active material. This will be described in more detail below.

In one or more embodiments of the present disclosure, a rechargeable lithium battery may include a negative electrode including the negative electrode active material for a rechargeable lithium battery, and a positive electrode.

### Positive Electrode

The positive electrode for a rechargeable lithium battery may include a positive electrode current collector and a positive electrode active material layer on the positive electrode current collector. The positive electrode active material layer may include a positive electrode active material (e.g., in a form of particles) and may further include a binder and/or a conductive material. In one or more embodiments, the positive electrode may further include an additive that may serve as a sacrificial positive electrode.

An amount of the positive electrode active material may be about 90 wt % to about 99.5 wt % based on a total weight of 100 wt % of the positive electrode active material layer. Amounts of the binder and the conductive material may each be about 0.5 wt % to about 5 wt % based on the total weight of 100 wt % of the positive electrode active material layer.

In one or more embodiments, the positive electrode active material may include a compound (lithiated intercalation compound) that is capable of intercalating and deintercalating lithium. For example, in one or more embodiments, at least one of a composite oxide of lithium and a metal selected from cobalt, manganese, nickel, and combinations thereof may be used.

The composite oxide may be a lithium transition metal composite oxide. Non-limiting examples of the composite oxide may include a lithium nickel-based oxide, a lithium cobalt-based oxide, a lithium manganese-based oxide, a lithium iron phosphate-based compound, a cobalt-free nickel-manganese-based oxide, or a combination thereof.

In one or more embodiments, the following compounds represented by any one selected from among the following Chemical Formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-g}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); and LiₐFePO₄ (0.90≤a≤1.8).

In the above Chemical Formulas, A may be nickel (Ni), cobalt (Co), manganese (Mn), or a combination thereof; X may be aluminum (Al), Ni, Co, Mn, chromium (Cr), iron (Fe), magnesium (Mg), strontium (Sr), vanadium (V), a rare earth element, or a combination thereof; D may be oxygen (O), fluorine (F), sulfur(S), phosphorus (P), or a combination thereof; G may be Al, Cr, Mn, Fe, Mg, lanthanum (La), cerium (Ce), Sr, V, or a combination thereof; and L¹ is Mn, Al, or a combination thereof.

In one or more embodiments, the positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of a total metal excluding lithium in the lithium transition metal composite oxide. The high-nickel-based positive electrode active material may be capable of realizing high capacity and can be applied to a high-capacity, high-density rechargeable lithium battery.

The binder serves to attach the positive electrode active material particles well to each other and also to attach the positive electrode active material well to the positive electrode current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Non-limiting examples of the conductive material may include a carbon-based material such as natural graphite, artificial graphite, carbon black, acetylene black, Ketjen black, a carbon fiber, a carbon nanofiber, and/or carbon nanotube; a metal-based material containing copper, nickel, aluminum, silver, etc., in a form of a metal powder or a metal fiber; a conductive polymer such as a polyphenylene derivative; or a mixture thereof.

In one or more embodiments, Al may be used as the positive electrode current collector, but embodiments of the present disclosure are not limited thereto.

### Negative Electrode

The negative electrode for a rechargeable lithium battery may include a negative electrode current collector and a negative electrode active material layer on the negative electrode current collector. The negative electrode active material layer may include a negative electrode active material (e.g., in a form of particles), and may further include a binder and/or a conductive material (e.g., an electrically conductive material).

For example, in one or more embodiments, the negative electrode active material layer may include about 90 wt % to about 99 wt % of the negative electrode active material, about 0.5 wt % to about 5 wt % of the binder, and about 0 wt % to about 5 wt % of the conductive material, based on a total weight of 100 wt % of the negative electrode material layer.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example, crystalline carbon, amorphous carbon, or a combination thereof. The crystalline carbon may be graphite such as non-shaped, sheet-shaped, flake-shaped, sphere-shaped, or fiber-shaped, natural graphite and/or artificial graphite. The amorphous carbon may be a soft carbon, a hard carbon, a mesophase pitch carbonization product, calcined coke, and/or the like.

The lithium metal alloy may include an alloy of lithium and a metal selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may include Sn, SnOₓ (0<x≤2) (e.g., SnO₂), a Sn-based alloy, or a combination thereof.

The silicon-carbon composite may be a composite of silicon and amorphous carbon. According to one or more embodiments, the silicon-carbon composite may be in a form of silicon particles and amorphous carbon coated on the surface of each of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may each be coated with the amorphous carbon. The secondary particle may exist dispersed in an amorphous carbon matrix.

In one or more embodiments, the silicon-carbon composite may further include crystalline carbon. For example, the silicon-carbon composite may include a core including crystalline carbon and silicon particles and an amorphous carbon coating layer on a surface of the core.

In one or more embodiments, the Si-based negative electrode active material or the Sn-based negative electrode active material may be used in combination with a carbon-based negative electrode active material.

The binder may serve to attach the negative electrode active material particles well to each other and also to attach the negative electrode active material well to the current collector. The binder may include a non-aqueous (e.g., water-insoluble) binder, an aqueous (e.g., water-soluble) binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

If (e.g., when) an aqueous binder is used as the binder of the negative electrode, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons may be used in the battery. Non-limiting examples thereof may include a carbon-based material such as natural graphite, artificial graphite, carbon black, acetylene black, Ketjen black, a carbon fiber, a carbon nanofiber, and/or a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

The electrolyte solution for a rechargeable lithium battery may include a non-aqueous organic solvent and a lithium salt.

The non-aqueous organic solvent may serve as a medium for transmitting ions that take part in the electrochemical reaction of the rechargeable lithium battery.

The non-aqueous organic solvent may be a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R-CN (wherein R is a C2 to C20 linear, branched, or cyclic hydrocarbon group, and may include a double bond, an aromatic ring, or an ether bond, and/or the like; amides such as dimethylformamide; dioxolanes such as 1,3-dioxolane, 1,4-dioxolane, and/or the like; sulfolanes; and/or the like.

The non-aqueous organic solvents may be used alone or in combination of two or more thereof.

In one or more embodiments, when using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the non-aqueous organic solvent supplies lithium ions in the rechargeable lithium battery, enables a basic operation of the rechargeable lithium battery, and improves transportation of the lithium ions between positive and negative electrodes. Non-limiting examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

Depending on the type of lithium secondary battery, a separator may exist between the positive electrode and the negative electrode. As such a separator, a multilayer film of two or more layers of polyethylene, polypropylene, polyvinylidene fluoride, or these individually may be used, and of course, a mixed multilayer film such as a polyethylene/polypropylene two-layer separator, a polyethylene/polypropylene/polyethylene three-layer separator, or a polypropylene/polyethylene/polypropylene three-layer separator may also be used.

The separator may include a porous substrate, and a coating layer including an organic material, an inorganic material, or a combination thereof located on one or both sides of the porous substrate.

The porous substrate may be a polymer film formed of any one polymer selected from among polyolefins such as polyethylene and/or polypropylene, polyesters such as polyethylene terephthalate and/or polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, a glass fiber, and polytetrafluoroethylene (e.g., Teflon), or a copolymer or a mixture of two or more of these.

The organic material may include a polyvinylidene fluoride-based polymer and/or a (meth)acrylic polymer.

The inorganic material may include inorganic particles selected from, but not limited to, Al₂O₃, SiO₂, TiO₂, SnO₂, CeO₂, MgO, NiO, CaO, GaO, ZnO, ZrO₂, Y₂O₃, SrTiOs, BaTiO₃, Mg(OH)2, boehmite, and combinations thereof.

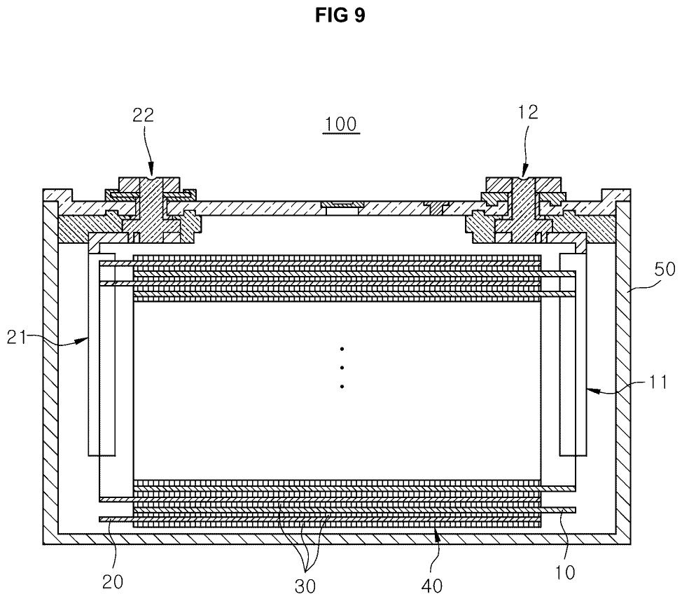

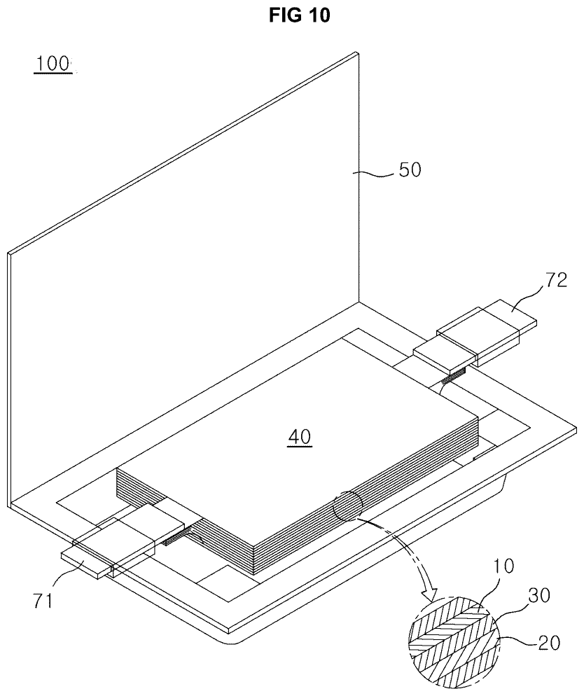

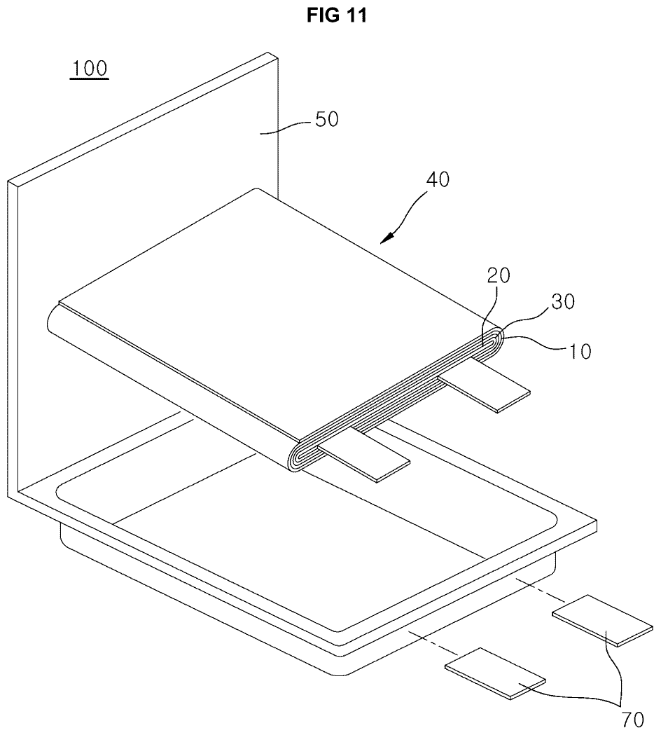

The rechargeable lithium battery may be classified into a cylindrical, prismatic, pouch, or coin-type battery, and/or the like depending on the shape thereof. FIGS. 8 to 11 are each a schematic view illustrating a rechargeable lithium battery according to one or more embodiments of the present disclosure. FIG. 8 shows a cylindrical battery, FIG. 9 shows a prismatic battery, and FIGS. 10 and 11 each show a pouch-type battery. Referring to FIGS. 8 to 11, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. In one or more embodiments, the rechargeable lithium battery 100 may include a sealing member 60 sealing the case 50, as shown in FIG. 8. In one or more embodiments, as shown in FIG. 9, the rechargeable lithium battery 100 may include a positive lead tab 11, a positive terminal 12, a negative lead tab 21, and a negative terminal 22. In one or more embodiments, as shown in FIGS. 10 and 11, the rechargeable lithium battery 100 may include an electrode tab 70, which may be, for example, a positive electrode tab 71 and a negative electrode tab 72, serving as an electrical path for inducing the current formed in the electrode assembly 40 to the outside.

The rechargeable lithium battery according to one or more embodiments may be applied to automobiles, mobile phones, and/or various types of electric devices, as non-limiting examples.

Hereinafter, an example and comparative examples of the present disclosure will be described. However, the following example is merely an example of the present disclosure, and the present disclosure is not limited to the following example.

### Example 1

Polyacrylonitrile (weight-average molecular weight 150,000 g/mol) was added to 10 mL of dimethylformamide, stirred at 90° C. for 4 hours, and fully dissolved to prepare a polyacrylonitrile dimethylformamide solution (10 wt % polyacrylonitrile). Thereafter, polymethyl methacrylate (weight-average molecular weight 120,000 g/mol) was added to the solution and stirred overnight until the polymethyl methacrylate was completely dissolved to prepare a first solution (a dimethylformamide solution containing 10 wt % polyacrylonitrile and 10 wt % polymethyl methacrylate).

The Flory-Huggins parameter between the dimethylformamide and the polyacrylonitrile was 0.662, and the Flory-Huggins parameter between the dimethylformamide and the polymethyl methacrylate was 0.229, thus resulting in an absolute difference of 0.433 between the Flory-Huggins parameters.

The prepared first solution was a uniform solution immediately after stirring. The solution was left to stand at room temperature. Phase separation of the solution over time is shown in FIG. 3.

After standing for 48 hours, a second solution including an intermediate layer was separated.

The obtained second solution was put in a syringe connected to a metal needle (gauge No. 28, inner diameter 0.18 mm) and electrospun under set/predetermined conditions (1.0 mLh⁻¹, an air atmosphere, a voltage of 19.5 kV, a distance of 18 cm between a nozzle and a collector, a spinning temperature of 22 to 25° C., a relative humidity of 18 to 20%) to prepare nanofibers. The nanofibers were then heated at a rate of 5° C./min in a nitrogen atmosphere to 750° C., followed by thermal treatment at 750° C. for 4 hours to prepare a carbon nanofiber bundle containing carbon nanofibers.

### Comparative Example 1

Polyacrylonitrile (weight-average molecular weight 150,000 g/mol) was added to 10 mL of dimethyl sulfoxide, stirred at 90° C. for 4 hours, and fully dissolved to prepare a polyacrylonitrile dimethyl sulfoxide solution (10 wt % polyacrylonitrile). Thereafter, polymethyl methacrylate (weight-average molecular weight 120,000 g/mol) was added to the solution and stirred overnight until the polymethyl methacrylate was completely dissolved to prepare a solution (a dimethyl sulfoxide solution containing 10 wt % polyacrylonitrile and 10 wt % polymethyl methacrylate).

The Flory-Huggins parameter between the dimethyl sulfoxide and the polyacrylonitrile was 0.365, and the Flory-Huggins parameter between the dimethyl sulfoxide and the polymethyl methacrylate was 0.301, thus resulting in an absolute difference of 0.064 between the Flory-Huggins parameters.

A phase separation process according to the standing time of the prepared solution is shown in FIG. 12.

Carbon nanofibers were prepared using the prepared solution in substantially the same manner as in Example 1.

### Comparative Example 2

Polyacrylonitrile was added to dimethylformamide and stirred until the polyacrylonitrile was completely dissolved to prepare a 10 wt % polyacrylonitrile dimethylformamide solution. The prepared dimethylformamide solution was electrospun and thermally treated in substantially the same manner as in Example 1 to prepare carbon nanofibers.

### Nitrogen Adsorption-Desorption Isotherm

The carbon nanofibers or carbon nanofiber bundles of each of the example and comparative examples were measured using nitrogen adsorption-desorption at 77 K and 1 bar pressure with a static volumetric gas adsorption instrument (Micrometrics ASAP 2020). Preliminary outgassing was performed at 150° C. for 10 hours. The results are shown in FIGS. 13 to 15.

Referring to FIG. 13, FIG. 13 illustrates a nitrogen adsorption-desorption curve of the carbon nanofiber bundle including the carbon nanofibers according to Example 1, showing H1 hysteresis in which the adsorption and desorption curves do not meet/coincide in both the first and second regions.

On the other hand, referring to FIG. 14, FIG. 14 illustrates a nitrogen adsorption-desorption curve of the carbon nanofibers according to Comparative Example 1, showing H1 hysteresis. It may be seen that, in the first region, the adsorption and desorption curves do not meet, but in the second region, the adsorption and desorption curves meet.

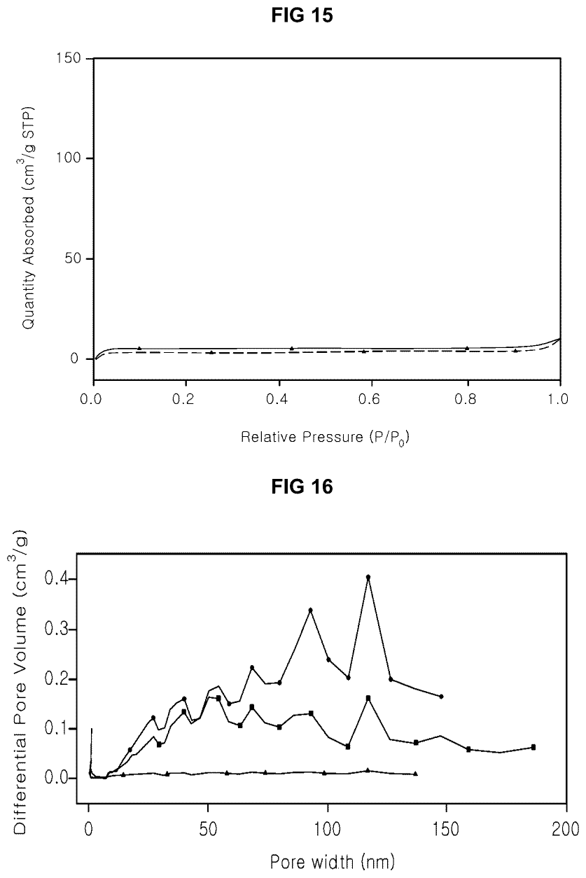

Further, referring to FIG. 15, a nitrogen adsorption-desorption curve of the carbon nanofibers according to Comparative Example 2 shows no H1 hysteresis.

### Specific Surface Area and Pore Volume

A specific surface area and a pore volume distribution of the carbon nanofibers or carbon nanofiber bundles of each of the example and comparative examples were evaluated using a static volumetric gas adsorption instrument (Micrometrics ASAP 2020). The results are shown in Table 1 below and FIG. 16.

TABLE 1

| | Specific surface area | Pore volume |
|---|---|---|
| | (m²g⁻¹) | (cm³g⁻¹) |
| Example 1 | 47.47 | 0.21 |
| Comparative Example 1 | 24.81 | 0.15 |
| Comparative Example 2 | 10.16 | 0.02 |

As shown in Table 1 and FIG. 16, it may be seen that the carbon nanofibers of the example exhibit a higher specific surface area and a higher pore volume compared to the carbon nanofibers of Comparative Examples 1 and 2.

### Electrochemical Impedance Spectroscopy (EIS) Evaluation

The carbon nanofibers or carbon nanofiber bundles prepared in each of the example and comparative examples were used as a negative electrode active material to prepare two types of electrodes (symmetric electrodes and half-cell electrodes), and then, the impedance, tortuosity, and lithium-ion diffusion coefficients thereof were calculated. The evaluations were performed before and after 500 cycles. The results are shown in Table 2 below and FIGS. 17 to 19. Charge transfer resistance (RCT) and solid electrolyte interphase resistance (RSEI) were evaluated.

For the evaluation, a negative electrode was prepared by mixing 70 wt % carbon nanofibers, which were prepared in the above-described example or respective comparative example, 15 wt % polyvinylidene fluoride as a binder, and 15 wt % carbon black as a conductive material to produce a slurry, which was then loaded onto a copper current collector at a loading amount of 1 to 1.5 mgcm⁻² and vacuum-dried at 80° C. for 1 hour. The electrolyte included ethyl carbonate (EC) and diethyl carbonate (DEC) in a 1:1 volume ratio, along with 1 M LiFP₆ salt.

Electrochemical experiments were performed using a 2032 coin-type half-cell assembled with a battery cycler (WBCS3000, WonATech) and a potentiostat (ZIVE SP2, WonATech). The experiment was performed for Li/Li⁺ in a voltage range of 0.02 to 2.0 V with a scan rate of 5 mV s⁻¹. Electrochemical impedance spectroscopy was performed at an open circuit voltage with an AC amplitude of 5 mV and a frequency range of 10 mHz to 10 KHz.

TABLE 2

| | | Diffusion | Diffusion |
|---|---|---|---|
| | | coefficient (cm²/s) | coefficient (cm²/s) |
| | Tortuosity | (before 500 cycles) | (after 500 cycles) |
| Example 1 | 3.90 | 1.05 × 10⁻¹² | 6.056 × 10⁻¹² |
| Comparative | 6.16 | 7.96 × 10⁻¹³ | 2.988 × 10⁻¹² |
| Example 1 | | | |
| Comparative | 6.71 | 2.01 × 10⁻¹⁴ | 1.719 × 10⁻¹² |
| Example 2 | | | |

TABLE 3

| | R_{CT} (Ω)(before | R_{CT} (Ω)(after | R_{SEI} |
|---|---|---|---|
| | 500 cycles) | 500 cycles) | (Ω) |
| Example 1 | 149.58 | 35.85 | 16.88 |
| Comparative | 168.13 | 54.13 | 23.79 |
| Example 1 | | | |
| Comparative | 257.60 | 132.99 | 47.76 |
| Example 2 | | | |

As shown in Table 2, Table 3, and FIGS. 17 to 19, it may be confirmed that the carbon nanofiber bundle including the carbon nanofibers of the example exhibits excellent electrochemical performance. Referring to FIG. 17, Example 1 has an Rᵢₒₙ/3 of 2.82Ω, Comparative Example 1 has an Rᵢₒₙ/3 of 3.97Ω, and Comparative Example 2 has an Rᵢₒₙ/3 of 4.34Ω.

Scanning Electron Microscope (SEM) photographs of carbon nanofibers and carbon nanofiber bundles.

SEM photographs were examined for the carbon nanofibers or carbon nanofiber bundles prepared in each of the example and comparative examples. The results are shown in FIGS. 20 to 22.

As shown in FIGS. 20 to 22, it may be confirmed that the carbon nanofiber bundle of Example 1 consists of a plurality of carbon nanofibers forming a bundle, the carbon nanofibers of Comparative Example 1 have pores formed within nanofibers, and the carbon nanofibers of Comparative Example 2 do not have pores formed.

The negative electrode active material for a rechargeable lithium battery according to one or more embodiments may exhibit a high charge/discharge rate and high efficiency.

As used herein, the term “Group” as utilized herein refers to a group of the Periodic Table of Elements according to the 1 to 18 grouping system of the International Union of Pure and Applied Chemistry (“IUPAC”).

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value. Also, it should be understood that, even if the terms “about,” “approximately,” or “substantially” are not expressly recited in a given element (e.g., a claim element), the scope of such element is intended to include variations that are insubstantial or within the understanding of one of ordinary skill in the art. For example, numerical values and ranges provided herein are intended to include tolerances and measurement uncertainties that would be recognized by those skilled in the art, and the elements (e.g., claim elements) should be construed accordingly to encompass such equivalents.

In the context of the present disclosure and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery (e.g., a positive electrode) manufacturing device, a battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Although the example embodiments of the present disclosure have been described above, the present disclosure is not limited thereto, and various modifications can be made within the scope of the claims and the detailed description of the disclosure and the accompanying drawings, and it is obvious that they also belong to the scope of the present disclosure. Therefore, the technical scope of the present disclosure is not to be limited to the content stated in the detailed description of the disclosure, but should be determined by the claims and equivalents thereof.

What is claimed is:

1. A negative electrode active material for a rechargeable lithium battery comprising a carbon nanofiber bundle including a plurality of carbon nanofibers,
wherein the carbon nanofiber bundle exhibits H1, H3, and H4 hysteresis in a gas adsorption-desorption isotherm curve, and,
in the gas adsorption-desorption isotherm curve, an adsorption curve and a desorption curve do not meet in all of a first region in which a relative pressure (P/P₀) is 0.8 or higher, a second region in which the relative pressure (P/P₀) is less than 0.8 and 0.4 or more, and a third region in which the relative pressure (P/P₀) is less than 0.4.

2. The negative electrode active material as claimed in claim 1, wherein the first region of the gas adsorption-desorption isotherm curve exhibits H1 hysteresis, and in first region the adsorption and desorption curves do not meet.

3. The negative electrode active material as claimed in claim 1, wherein the second region and the third region of the gas adsorption-desorption isotherm curve exhibit H3 and H4 hysteresis, and in the second region and the third region the adsorption and desorption curves do not meet.

4. The negative electrode active material as claimed in claim 1, wherein the carbon nanofiber bundle has pore channels composed of void spaces between the carbon nanofibers.

5. The negative electrode active material as claimed in claim 1, wherein pore channels between the carbon nanofibers in the carbon nanofiber bundle have an average diameter in a range of 50 nm to 150 nm.

6. The negative electrode active material as claimed in claim 1, wherein the carbon nanofiber bundle has a specific surface area in a range of 30 m² g⁻¹ to 100 m² g⁻¹.

7. The negative electrode active material as claimed in claim 1, wherein the carbon nanofiber bundle has a pore volume of 0.2 cm³ g⁻¹ or more.

8. A method for preparing a negative electrode active material for a rechargeable lithium battery, the method comprising:
preparing a first solution including a solvent, a first carbon-containing polymer whose Flory-Huggins parameter with respect to the solvent is F1, and a second carbon-containing polymer whose Flory-Huggins parameter with respect to the solvent is F2, wherein an absolute value of a difference between F1 and F2 is 0.4 or more;
performing phase separation on the first solution to obtain a second solution including an intermediate layer; and
electrospinning and thermally treating the second solution to prepare a carbon nanofiber bundle including a plurality of carbon nanofibers.

9. The method as claimed in claim 8, wherein F1 is 0.6 or more.

10. The method as claimed in claim 8, wherein F2 is 0.1 or more.

11. The method as claimed in claim 8, wherein the first carbon-containing polymer and the second carbon-containing polymer are each independently selected from one or more of polyacrylonitrile and polymethyl methacrylate.

12. The method as claimed in claim 8, wherein the solvent includes one or more selected from among dimethylformamide, dimethylacetamide, methylpyrrolidone, and dimethyl sulfoxide.

13. The method as claimed in claim 8, wherein the intermediate layer includes a sea-island structure consisting of an island region containing the first carbon-containing polymer and a sea region made of the second carbon-containing polymer, and
wherein the island region further includes an island region containing the second carbon-containing polymer therein.

14. The method as claimed in claim 8, wherein the phase separation includes spontaneous phase separation.

15. A rechargeable lithium battery comprising a negative electrode and a positive electrode, wherein the negative electrode includes the negative electrode active material as claimed in claim 1.

16. A rechargeable lithium battery comprising a negative electrode and a positive electrode, wherein the negative electrode includes a negative electrode active material prepared by the method as claimed in claim 8.
